(19) United States
(12) Patent Application Publication
(10) Pub. No.: US 2008/0170736 A1
(43) Pub. Date: Jul. 17, 2008

(54) Sound broadcasting mechanism and electronic device using the same

(75) Inventors: Wen-Ting Yu, Taipei (TW); Mingsian R. Bai, Taipei (TW); Rong-Liang Chen, Taipei (TW)

Correspondence Address: RABIN & Berdo, PC, 1101 14TH STREET, NW, SUITE 500, WASHINGTON, DC, 20005, US

(73) Assignees: ASUSTEK COMPUTER INC., Taipei (TW); NATIONAL CHIAO TUNG UNIVERSITY, Hsinchu (TW)

(21) Appl. No.: 12/003,744

(22) Filed: Dec. 31, 2007

(30) Foreign Application Priority Data
Jan. 12, 2007 (TW) 096101334

(51) Int. Cl. H04R 1/02

(52) U.S. Cl. 381/345

(57) ABSTRACT

A sound broadcasting mechanism and an electronic device using the same are provided. The sound broadcasting mechanism includes a sound box, a sound broadcasting element and a sound enhancing element. The sound broadcasting element is disposed at the surface of the sound box to generate a sound signal. The sound enhancing element is disposed at the surface of the sound box. The sound enhancing element includes a resonating film and a weight increasing element. The resonating film can resonate with the sound signal in a resonating frequency range to enhance the sound intensity of the sound signal in the resonating frequency range. The weight increasing element is attached to the surface of the resonating film. The weight of the weight increasing element is related to the resonating frequency range.

This application claims the benefit of Taiwan application Serial No. 96101334, filed Jan. 12, 2007, the subject matter of which is incorporated herein by reference.

### BACKGROUND OF THE INVENTION

1. Field of the Invention

The invention relates to a sound broadcasting mechanism and an electronic device using the same and, more particularly, to a small sound broadcasting mechanism and an electronic device using the same.

2. Description of the Related Art

With the development of the science and technology, various novel electronic devices which bring people a lot of convenience and fun in daily life appear. Many electronic devices are equipped with sound broadcasting mechanisms. A sound signal can be broadcasted by the sound broadcasting mechanism to broadcast music or information or do the operation such as oral communication and so on.

Please refer to FIG. 1. FIG. 1 is a schematic diagram showing a conventional sound broadcasting mechanism 900 including a sound box 940 and a loudspeaker 950. The loudspeaker 950 includes a conducting coil 951, a metal element 952 and a vibrating film 953. The conducting coil 951 and the metal element 952 are disposed in the sound box 940, and the conducting coil 951 is round the metal element 952. When the alternating current is inputted into the conducting coil 951, a magnetic filed is generated by the conducting coil 951 and the metal element 952. The magnetic filed charges with the amount and the direction of the alternating current and makes the vibrating film 953 vibrate with the change of the magnetic filed. After the vibrating film 953 vibrates, it generates a sound signal S9, and the sound signal S9 is transmitted to the environment after resonating in the sound box 940.

However, the portable electronic device such as a mobile phone, a personal digital assistant (PDA), a notebook, a digital camera or a global positioning system (GPS) receiving device and so on is continuously developed to be “light, slim, short and small”. Therefore, the sound box 940 of the sound broadcasting mechanism 900 of the portable electronic device becomes smaller and smaller, even smaller than four cc., so that when the sound signal S9 sent out by the loudspeaker 950 resonates in the sound box 940, the resonating effect in the bass frequency range becomes very bad.

Therefore, how to provide a sound broadcasting mechanism and an electronic device using the same to solve the problem that the small sound box has a bad effect in the bass frequency range is one of the important subjects to be researched and developed now.

### BRIEF SUMMARY OF THE INVENTION

One objective of the invention is to provide a sound broadcasting mechanism and an electronic device using the same. In the invention, the characteristic that the sound enhancing element resonates in a resonating frequency range is utilized to enhance the sound signal of the sound broadcasting mechanism in the resonating frequency range, so that the sound broadcasting mechanism of the invention and the electronic device using the same have the effect of “obtaining the best bass resonating effect in a sound box with a small size”, “not affecting other electronic elements”, “having a low cost”, “using conveniently”, “having surround sound effect and multidirectional transmission effect” and “having the effect of phasing separation”.

According to one objective of the invention, a sound broadcasting mechanism is provided. The sound broadcasting mechanism includes a sound box, a sound broadcasting element and a sound enhancing element. The sound broadcasting element is provided at the surface of the sound box. The sound broadcasting element is used to generate sound signals. The sound enhancing element is provided at the surface of the sound box and includes a resonating film and a weight increasing element. The resonating film can resonate with the sound signals in a resonating frequency range to enhance the sound intensity of sound signals in a specific resonating frequency range. The weight increasing element is attached to the surface of the resonating film. The weight of the weight increasing element is related to the resonating frequency range.

According to another objective of the invention, an electronic device is provided. The electronic device includes a case, a control unit and a sound broadcasting mechanism. The control unit is provided in the casing. The sound broadcasting mechanism includes a sound box, a sound broadcasting element and a sound enhancing element. The sound broadcasting element is provided at the surface of the sound box, the control unit is electrically connected to the sound broadcasting element to control the sound broadcasting element to generate a sound signal, and the sound enhancing element is provided at the surface of the sound box. The sound enhancing element includes a resonating film and a weight increasing element. The resonating film can resonate with the sound signals in a resonating frequency range to enhance the sound intensity of the sound signal in a resonating frequency range. The weight increasing element is attached to the surface of the resonating film. The weight of the weight increasing element is related to the resonating frequency range.

These and other features, aspects, and-advantages of the present invention will become better understood with regard to the following description, appended claims, and accompanying drawings.

### BRIEF DESCRIPTION OF THE DRAWINGS

FIG. 1 is a schematic diagram showing a conventional sound broadcasting mechanism;

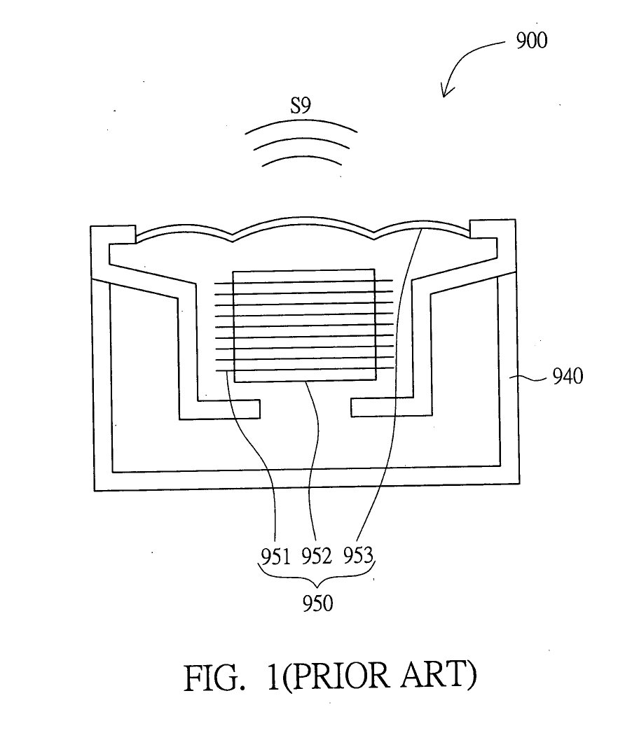

FIG. 2 is a schematic diagram showing the sound broadcasting mechanism and the electronic device using the same according to the first embodiment of the invention;

FIG. 3 is an exploded diagram showing the sound broadcasting mechanism and the electronic device using the same shown in FIG. 2;

FIG. 4 is a top view showing the sound broadcasting mechanism and the electronic device using the same shown in FIG. 2;

FIG. 5 is a section diagram showing the sound broadcasting mechanism shown in FIG. 4 along the line 5-5′;

FIG. 6 is a measuring diagram showing the sound broadcasting mechanism of the embodiment;

FIG. 7 is a sound broadcasting mechanism and the electronic device using the same according to the second embodiment of the invention;

FIG. 8 is a sound broadcasting mechanism and the electronic device using the same according to the third embodiment of the invention;

FIG. 9 is a sound broadcasting mechanism and the electronic device using the same according to the fourth embodiment of the invention; and

FIG. 10 is a sound broadcasting mechanism and the electronic device using the same according to the fifth embodiment of the invention.

### DETAILED DESCRIPTION OF THE EMBODIMENTS

### First Embodiment

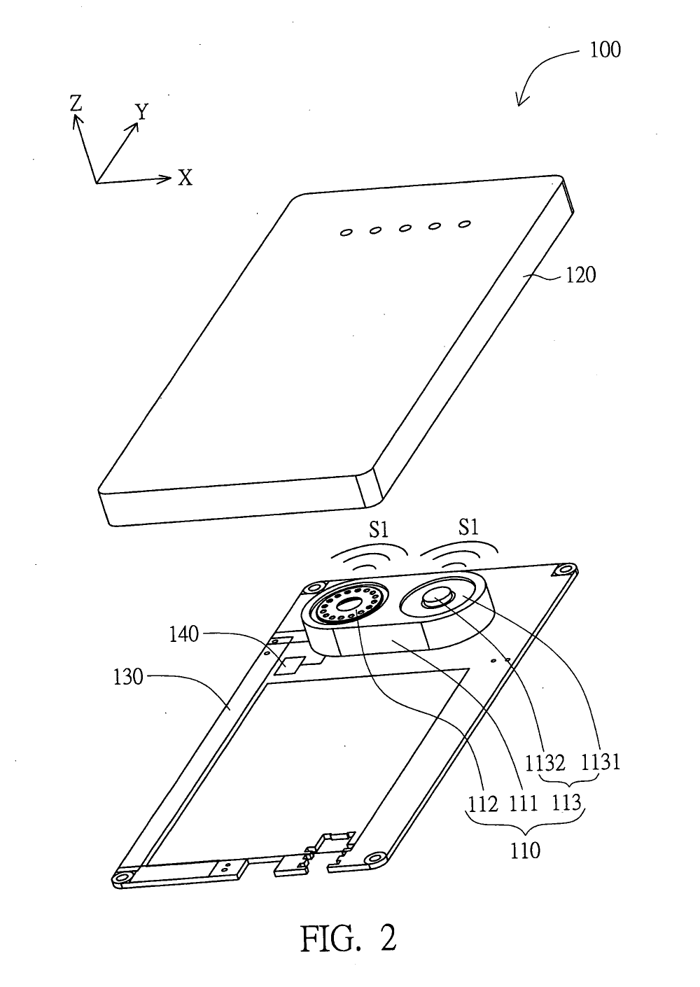

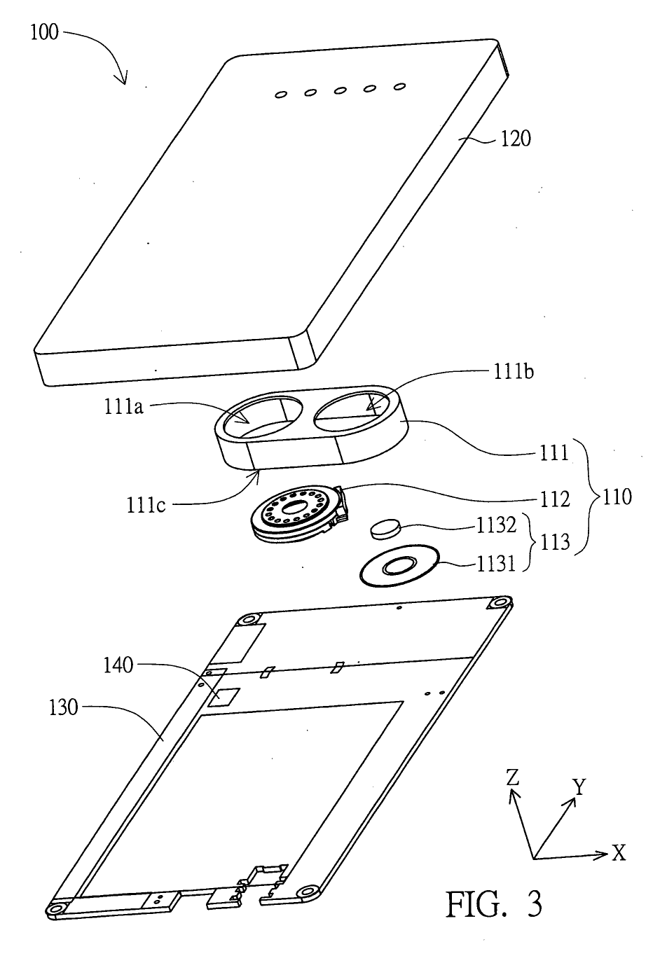

Please refer to FIG. 2 and FIG. 3 simultaneously. FIG. 2 is a schematic diagram showing a sound broadcasting mechanism 110 and an electronic device 100 using the same according to one embodiment of the invention. FIG. 3 is an exploded diagram showing the sound broadcasting mechanism 110 and the electronic device 100 using the same shown in FIG. 2. The electronic device 100 includes a casing 120, a control unit 140 and a sound broadcasting mechanism 110. The control unit 140 is provided in the casing 120. The sound broadcasting mechanism 110 includes a sound box 111, a sound broadcasting element 112 and a sound enhancing element 113. The sound broadcasting element 112 is provided at the surface of the sound box 111. The control unit 140 is electrically connected to the sound broadcasting element 112 to control the sound broadcasting element 112 to make a sound signal S1. The sound enhancing element 113 is provided at the surface of the sound box 111 and includes a resonating film 1131 and a weight increasing element 1132. The resonating film 1131 resonates in a resonating frequency range which usually is 400 Hz to the first resonating point of the sound broadcasting element 112 to enhance the sound intensity of the sound signal S1 in the resonating frequency range. The weight increasing element 1132 is attached to the surface of the resonating film 1131. The weight of the weight increasing element 1132 is related to the resonating frequency range.

In the embodiment, the sound enhancing element 113 has a best resonating effect in the resonating frequency range of 400 Hz to 500 Hz. Usually, the sound box 111 with a small size (such as a size smaller than 4 cc., in the embodiment, the size of the sound box 111 is 1.5 cc.) has an unpreferred effect in the low resonating frequency range of 400 Hz to 500 Hz, and via the sound enhancing element 113 of the invention, the sound signal S1 in the resonating frequency range of 400 Hz to 500 Hz can be enhanced effectively.

The electronic device 100 further includes a circuit board 130 provided in the casing 120. As shown in FIG. 3, the sound box 111 has a first opening 111a, a second opening 111b and a third opening 111c. The sound broadcasting element 112 is provided at the first opening 111a in a closed mode. The sound enhancing element 113 is provided at the second opening 111b in a closed mode. The third opening 111c is coupled to the circuit board 130 in a closed mode to make the sound box 111 form a closed room. The sound signal S1 generated by the sound broadcasting element 112 can resonate in the closed room.

In addition, the sound box 111 not only can be coupled to the circuit board 130 via the third opening 111c, it also can be coupled to the casing 120 via the third opening 111c to form a closed room. Users can make proper adjustment according to the structure design of the electronic device 100.

As shown in FIG. 2, the sound broadcasting element 112 and the sound enhancing element 113 are in the same sound box 111. When the sound signal S1 generated by the sound broadcasting element 112 resonates in the sound box 111, the sound enhancing element 113 also receives the sound signal S1 and resonates synchronously to enhance the sound signal S1.

In addition, the sound broadcasting element 112 and the sound enhancing element 113 of the embodiment are provided at the same side of the sound box 111 (that is, the positive position of Z axis). Therefore, the sound broadcasting element 112 and the sound enhancing element 113 can transmit the sound signal S1 along the same direction to obtain effect of surround sound effect, multi-directional transmission.

Please refer to FIG. 3. When the resonating film 1131 resonates with the sound signal S1, the weight of the weight increasing element 1132 is related to the resonating frequency range. A user can adjust the weight of the weight increasing element 1132 properly (such as 100˜300 mg, in the embodiment, the weight of the weight increasing element 1132 is 200 mg). That is, the sound enhancing element 113 of the embodiment can obtain a best effect in the resonating frequency range of 400 Hz to 500 Hz.

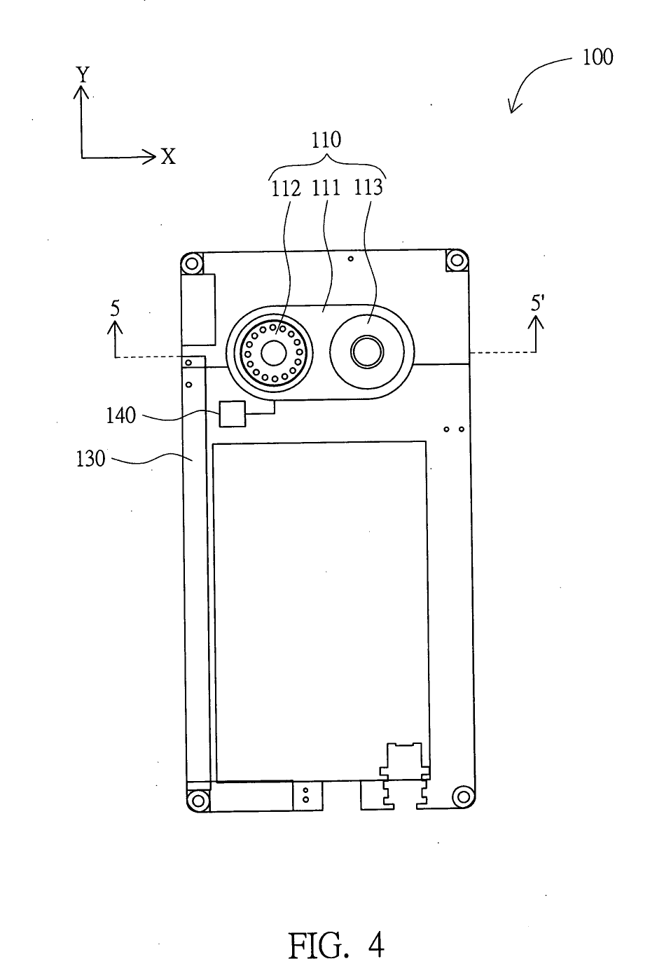

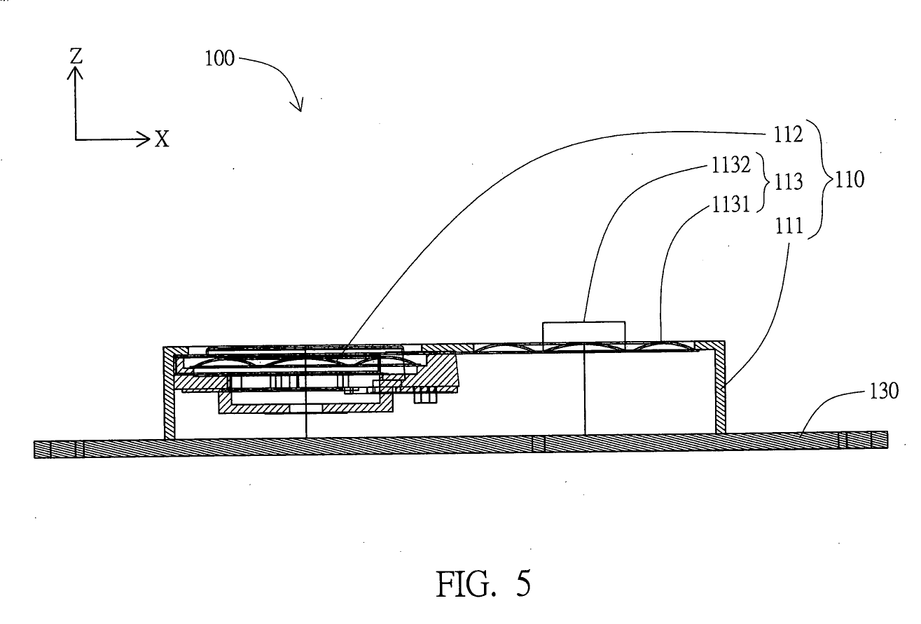

Please refer to FIG. 4˜FIG. 5. FIG. 4 is a top view showing the sound broadcasting mechanism 110 and the electronic device 100 using the same shown in FIG. 2. FIG. 5 is a section diagram showing the sound broadcasting mechanism 110 shown in FIG. 4 along the line 5-5′. As shown in FIG. 5, the weight increasing element 1132 is attached to the center of the resonating film 1131. When the resonating film 1131 resonates, since the weight increasing element 1132 has a certain weight, the resonating film 1132 swings slowly, and then the sound enhancing element 113 of the embodiment resonates easily in the low frequency range.

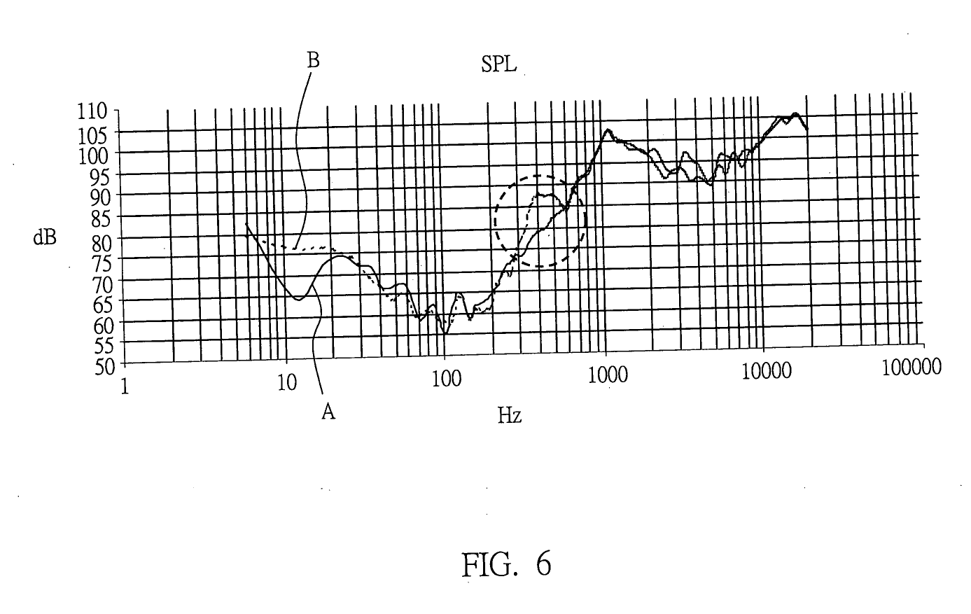

Please refer to FIG. 6, which is a measuring diagram of the sound broadcasting mechanism 110 of the embodiment. Curve A denotes the measuring curve of the resonating film 1131 which is not attached by the weight increasing element 1132. Curve B denotes the measuring curve of the resonating film 1131 which is attached by the weight increasing element 1132. The horizontal axis in FIG. 6 denotes the resonating frequency (Hz), and the vertical axis denotes the increment value (dB). Compared with the increment value of the curve A, the increment value of the curve B in the resonating frequency range of 400 Hz to 500 Hz is obviously much higher (as shown by the dotted line area in FIG. 6). That is, the sound broadcasting mechanism 110 which is attached by the weight increasing element 1132 has a very good effect in the resonating frequency range of 400 Hz to 500 Hz.

In addition, the material of the resonating film 1131 also affects the resonating frequency range of the sound enhancing element 113. Generally speaking, the harder the material (such as metal) is, the higher the resonating frequency is; the softer the material (such as plastic) is, the lower the resonating frequency is. In the embodiment, the sound enhancing element 113 is used to enhance the sound signal S1 in the bass frequency range, so that the plastic film is used to make the resonating film 1131 of the embodiment.

Furthermore, the thickness of the resonating film 1131 also affects the resonating frequency range of the sound enhancing element 113. The thinner the resonating film 1131 is, the more easily the resonating film 113 swings, and the higher the resonating frequency of the resonating film 1131 is. The thicker the resonating film 1131 is, the more difficultly the resonating film 1131 swings, and the lower the resonating frequency of the resonating film 1131 is. A user can adjust the thickness of the resonating film 1131 according to the actual demand.

As stated above, the sound enhancing element 113 can resonate in the resonating frequency range which needs to be enhanced by adjusting the weight of the weight increasing element 1132, the material of the resonating film 1132 or the thickness of the resonating film 1131 properly.

In addition, if the air tightness of the sound box 111 needs to be increased, the resonating film 1131 and the sound box 111 can be integrally formed to keep the air tightness of the sound box 111 good. Otherwise, when the material of the resonating film 1131 and that of the sound box 111 are different, rubber or sponge also can be assembled to form a closed room.

As stated above, the sound enhancing element 113 enhances the sound signal S1 in the low resonating frequency range, so that the sound broadcasting mechanism 110 can obtain best bass effect without adding any complex component (such as a loudspeaker) or increasing the size of the sound box 111.

### Second Embodiment

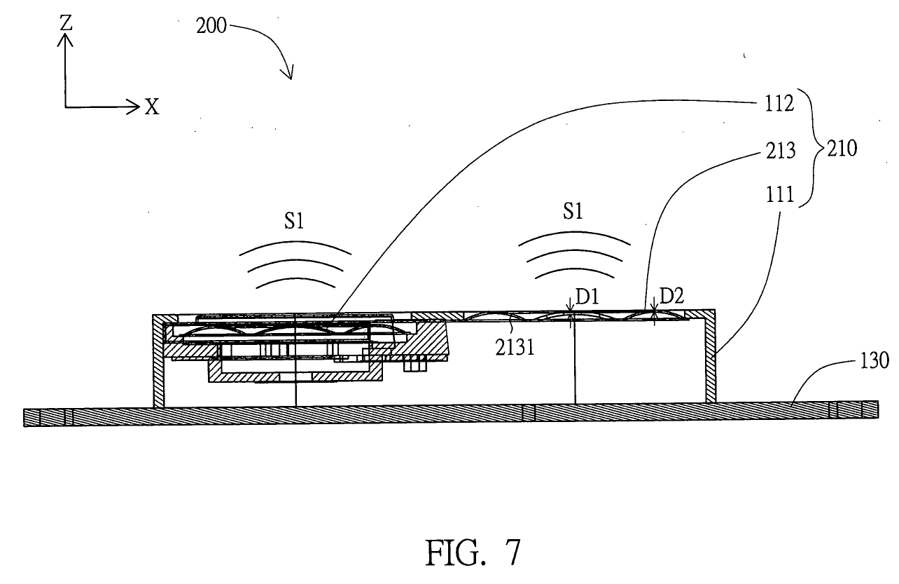

The difference between the sound broadcasting mechanism 210 and the electronic device 200 using the same of the embodiment and the sound broadcasting mechanism 110 and the electronic device 100 using the same of the first embodiment is the structure of the resonating film 2131, and others which are same are not described for concise purpose. Pleaser refer to FIG. 7, which is a schematic diagram showing the sound broadcasting mechanism 210 and the electronic device 200 using the same according to the second embodiment of the invention. In the embodiment, the center of the resonating film 2131 has a first thickness D1, and the edge of the resonating film 2131 has a second thickness D2. The first thickness D1 is larger than the second thickness D2. Since second thickness D2 of the edge of the resonating film 2131 is thinner, the edge of the resonating film 2131 is softer than the center, and since the first thickness D1 of the center of the resonating film 2131 is thicker, the center of the resonating film 2131 is thicker than the edge. The structure enables the resonating film 2131 to swing slower, and then a preferred resonating effect in the low resonating frequency range can obtained.

### Third Embodiment

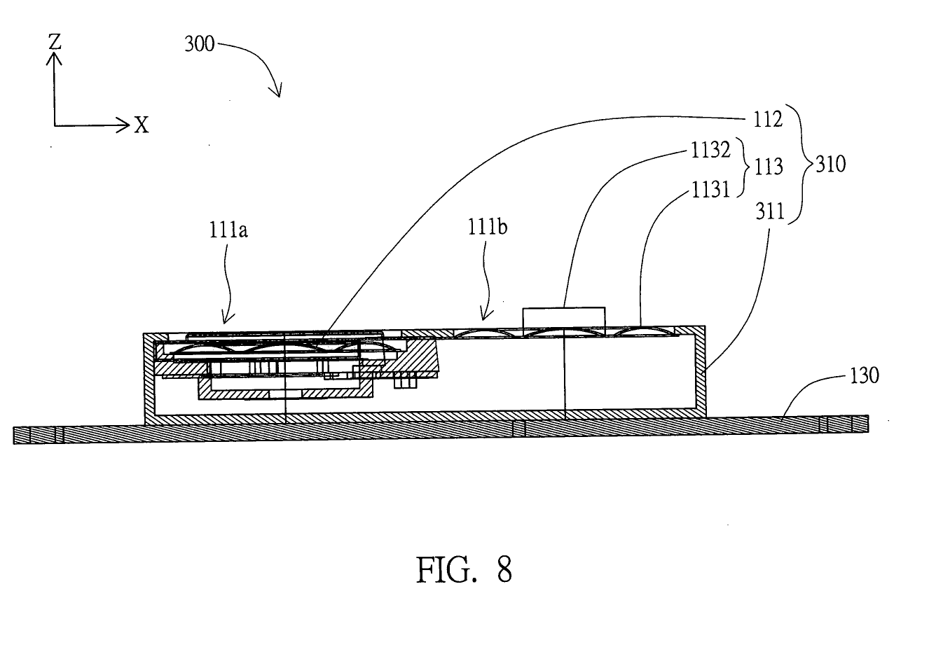

The difference between the sound broadcasting mechanism 310 and the electronic device 300 using the same of the embodiment and the sound broadcasting mechanism 110 and the electronic device 100 using the same of the first embodiment is the structure of the sound box 311, and others which are same are not described for concise purpose. Please refer to FIG. 8, which is a schematic diagram showing the sound broadcasting mechanism 310 and the electronic device 300 using the same according to the third embodiment of the invention. In the embodiment, the sound box 311 has a first opening 111a and a second opening 111b. The sound broadcasting element 112 is provided at the first opening 111a in a closed mode, and the sound enhancing element 113 is provided at the second opening 111b in a closed mode to make the sound box 311 form a closed room. Since the sound box 111 only has a first opening 111a and a second opening 111b, after the sound broadcasting element 111 and the sound enhancing element 113 are provided at the first opening 111a and the second opening 111b, respectively, the sound box 311 forms a closed room. That is, the sound broadcasting mechanism 310 can be independently provided outside the circuit board 130 or the casing 120. For some electronic device, the sound broadcasting mechanism 310 of the embodiment can be used according to the need of the design, and how to keep good air tightness with the circuit board or the casing does not need to be considered, so that mechanism design of the electronic device is more convenient.

### Fourth Embodiment

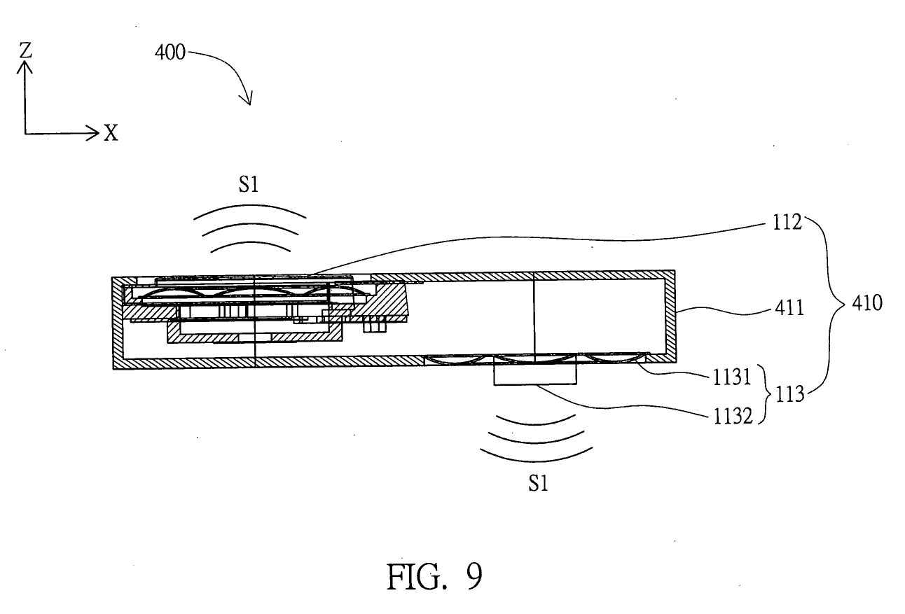

The difference between the sound broadcasting mechanism 410 and the electronic device 400 using the same of the embodiment and the sound broadcasting mechanism 110 and the electronic device 100 using the same of the first embodiment is the relative position of the sound broadcasting element 112 and the sound enhancing element 113, and others which are same are not described for concise purpose. Please refer to FIG. 9, which is a schematic diagram showing the sound broadcasting mechanism 410 and the electronic device 400 using the same according to the fourth embodiment. In the embodiment, the sound broadcasting element 112 and the sound enhancing element 113 are provided at two opposite sides of the sound box 411. Therefore, the sound signal S1 generated by the sound broadcasting element 112 can be transmitted along two direction (that is, positive direction and negative direction of the Z axis in FIG. 9). When the above structure is applied to the some electronic devices, the effect of surround sound effect, multi-directional transmission further can be obtained. A user can utilize it according to the design demand of the electronic devices.

### Fifth Embodiment

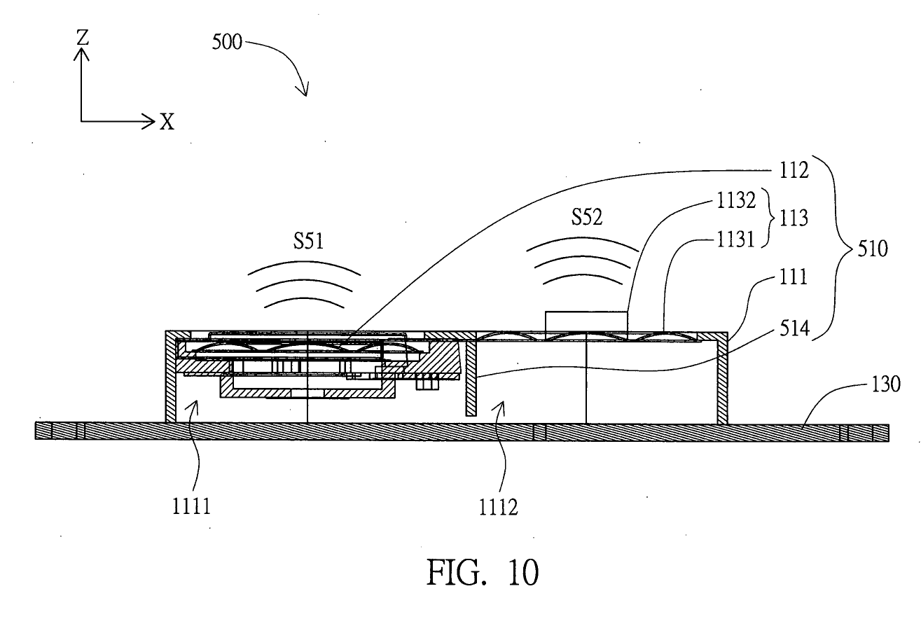

The difference between the sound broadcasting mechanism 510 and the electronic device 500 using the same of the embodiment and the sound broadcasting mechanism 110 and the electronic device 100 using the same of the first embodiment is that the sound broadcasting mechanism 510 further includes a partition 514, and others which are same are not described for concise purpose. Please refer to FIG. 10, which is a schematic diagram showing the sound broadcasting mechanism 510 and the electronic device 500 using the same according to the fifth embodiment of the invention. In the embodiment, the sound broadcasting mechanism 510 further includes a partition 514. The partition 514 is provided between the sound broadcasting element 112 and the sound enhancing element 113. The partition 514 actually divides the sound box 111 into a first resonating room 1111 and a second resonating room 1112 which are interlinked with each other. After the sound broadcasting element 112 generates a first sound signal S51, the first sound signal S51 resonates in the first resonating room 1111. After the first sound signal S51 is reflected by the partition 514, it forms a second sound signal S52 whose phase is opposite to the phase of the first sound signal S51 when it is transmitted to the second resonating room 1112. The second sound signal S52 resonates with the sound enhancing element 113, so that the phase of the vibrating frequency of the sound broadcasting element 112 separates from the phase of the vibrating frequency of the sound enhancing element 113.

In the embodiment, the sound broadcasting mechanism 510 utilizes the partition 514 to divide the sound box 111 into the first resonating room 1111 and the second resonating room 1112, so that the phase of the vibrating frequency of the sound broadcasting element 112 separates from the phase of the vibrating frequency of the sound enhancing element 113. Phase separation means that separating the sound pressure in two different directions of the sound broadcasting mechanism 510 to avoid counteracting mutually and weakening of the sound pressure. The sound broadcasting mechanism 510 also can utilize a sound guiding tube coupled to the sound box 111 to make the phase of the vibrating frequency of the sound broadcasting element 112 separates from the phase of the vibrating frequency of the sound enhancing element 113 via the reflection of the sound signal in the sound guiding tube.

The sound broadcasting mechanism and the electronic device using the same of the embodiment of the invention utilizes the characteristic that a sound enhancing element resonates in a resonating frequency range to enhance the sound signal of the sound broadcasting mechanism in the resonating frequency range. The sound broadcasting mechanism and the electronic device using the same of the invention have at least the following advantages.

First advantage is that “obtaining the best bass resonating effect in a sound box with a small size”. The sound broadcasting mechanism of the invention can obtain a best bass resonating effect only by providing a sound enhancing element without increasing the size of the sound box, which satisfies the developing trend “light, slim, short and small” of the electronic device and solves the long problem that the bass effect of the small sound box is not preferred.

Second advantage is that “not affecting other electronic elements”. In a small electronic device, each electronic component is crowdedly provided in the electronic device. The operation of electronic components such as an antenna and a chip are easily affected by the wire and metal. The sound enhancing element of the invention does not have wires or metal, so that the affection on other electronic components can be reduced to be lowest.

Third advantage is that “having a low cost”. The material cost and the manufacturing cost of the sound enhancing element are both low, so that the sound broadcasting mechanism and the electronic device using the same of the invention can be mass-manufactured.

Fourth advantage is that “using conveniently”. The sound broadcasting mechanism further can independently form a single structure with good air tightness, so that the sound broadcasting mechanism can be used in various electronic devices.

Fifth advantage is that “having the surround sound effect and multi-directional transmission effect”. The sound signal of the sound broadcasting mechanism can be transmitted to the environment via the sound broadcasting element and the sound enhancing element. According to the position where the sound broadcasting element and the sound enhancing element are provided, the surround sound effect and multi-directional transmission effect can be obtained.

Sixth advantage is “having effect of phase separation”. The sound broadcasting mechanism can make the phase of the resonating frequency of the sound broadcasting element separate from the phase of the resonating frequency of the sound enhancing element via a partition or a sound guiding tube.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A sound broadcasting mechanism comprising:
a sound box;
a sound broadcasting element provided at the surface of the sound box and used for generating a sound signal; and
a sound enhancing element provided at the surface of the sound box, the sound enhancing element comprising:
a resonating film which can resonate with the sound signal in a resonating frequency range to enhance the sound intensity of the sound signal in the resonating frequency range; and
a weight increasing element which is attached to the surface of the resonating film, wherein the weight of the weight increasing element is related to the resonating frequency range.

2. The sound broadcasting mechanism according to claim 1, wherein the resonating film and the sound box are integrally formed.

3. The sound broadcasting mechanism according to claim 1, wherein the weight of the weight increasing element is 100 mg to 300 mg, and the resonating frequency range is 400 Hz to the first resonating point of the sound broadcasting element.

4. The sound broadcasting mechanism according to claim 1, wherein the material of the resonating film is related to the resonating frequency range.

5. The sound broadcasting mechanism according to claim 1, wherein the center of the resonating film has a first thickness, while the edge of the resonating film has a second thickness, and the first thickness is larger than the second thickness.

6. The sound broadcasting mechanism according to claim 1, wherein the sound broadcasting element and the sound enhancing element are provided at the same side of the sound box.

7. The sound broadcasting mechanism according to claim 1, wherein the sound broadcasting element and the sound enhancing element are provided at two opposite sides of the sound box.

8. The sound broadcasting mechanism according to the claim 1, wherein the sound box has a first opening and a second opening, and the sound broadcasting element is provided at the first opening in a closed mode, and the sound enhancing element is provided at the second opening in a closed mode to make the sound box form a closed room.

9. The sound broadcasting mechanism according to the claim 1, wherein the sound box has a first opening, a second opening and a third opening, and the sound broadcasting element is provided at the first opening in a closed mode, the sound enhancing element is provided at the second opening in a closed mode, and the third opening is coupled to a circuit board or a casing of an electronic device in a closed mode to make the sound box form a closed room.

10. The sound broadcasting mechanism according to the claim 1, wherein the resonating frequency range is 400 Hz to the first resonating point of the sound broadcasting element.

11. The sound broadcasting mechanism according to the claim 1 further comprising:
a partition provided between the sound broadcasting element and the sound enhancing element and used for making the phase of the vibrating frequency of the sound broadcasting element separate from phase of the vibrating frequency of the sound enhancing element.

12. The sound broadcasting mechanism according to the claim 1 further comprising:
a sound guiding tube coupled to the sound box to make the phase of the vibrating frequency of the sound broadcasting element separate from the phase of the vibrating frequency of the sound enhancing element.

13. The sound broadcasting mechanism according to the claim 1, wherein the size of the sound box is smaller than four cc.

14. An electronic device comprising:
a casing;
a control unit provided in the casing; and
a sound broadcasting mechanism comprising:
a sound box;
a sound broadcasting element provided at the surface of the sound box, wherein the control unit is electrically connected to the sound broadcasting element to control the sound broadcasting element to generate a sound signal; and
a sound enhancing element provided at the surface of the sound box, the sound enhancing element comprising:
a resonating film which can resonate with the sound signal in a resonating frequency range to enhance the sound intensity of the sound signal in the resonating frequency range; and
a weight increasing element attached to the surface of the resonating film, wherein the weight of the weight increasing element is related to the resonating frequency range.

15. The electronic device according to claim 14, wherein the resonating film and the sound box are integrally formed.

16. The electronic device according to claim 14, wherein the weight of the weight increasing element is 100 to 300 mg, and the resonating frequency range is 400 Hz to the first resonating point of the sound broadcasting element.

17. The electronic device according to claim 14, wherein the material of the resonating film is related to the resonating frequency range.

18. The electronic device according to claim 14, wherein the center of the resonating film has a first thickness, while the edge of the resonating film has a second thickness, and the first thickness is larger than the second thickness.

19. The electronic device according to claim 14, wherein the sound broadcasting element and the sound enhancing element are provided at the same side of the sound box.

20. The electronic device according to claim 14, wherein the sound broadcasting element and the sound enhancing element are provided at two opposite sides of the sound box.

21. The electronic device according to claim 14, wherein the sound box has a first opening and a second opening, and the sound broadcasting element is provided at the first opening in a closed mode, and the sound enhancing element is provided at the second opening in a closed mode to make the sound box form a closed room.

22. The electronic device according to claim 14 further comprising:
a circuit board provided in the casing;
wherein the sound box has a first opening, a second opening and a third opening, and the sound broadcasting element is provided at the first opening in a closed mode, the sound enhancing element is provided at the second opening in a closed mode, and the third opening is coupled to the circuit board or the casing in a closed mode to make the sound box form a closed room.

23. The electronic device according to claim 14, wherein the resonating frequency range is 400 Hz to a first resonating point of the sound broadcasting element.

24. The electronic device according to claim 14, wherein the sound broadcasting mechanism further comprises:
a partition provided between the sound broadcasting element and the sound enhancing element and used for making the phase of the vibrating frequency of the sound broadcasting element separate from the phase of the vibrating frequency of the sound enhancing element.

25. The electronic device according to claim 14, wherein the sound broadcasting mechanism further comprises:
a sound guiding tube coupled to the sound box to make the phase of the vibrating frequency of the sound broadcasting element separate from the phase of the vibrating frequency of the sound enhancing element.

26. The electronic device according to claim 14, wherein the size of the sound box is smaller than four cc.
